(19) United States
(12) Patent Application Publication
(10) Pub. No.: US 2004/0228215 A1
(43) Pub. Date: Nov. 18, 2004

(54) Sound source localization system, and sound reflecting element

(75) Inventors: Osamu Ichikawa, Ebina-shi (JP); Masafumi Nishimura, Yokohama-shi (JP)

Correspondence Address: Louis P. Herzberg, IBM Corporation, Intellectual Property Law Dept., P.O. Box 218, Yorktown Heights, NY, 10598, US

(73) Assignee: International Business Machines Corporation, Armonk, NY

(21) Appl. No.: 10/801,440

(22) Filed: Mar. 16, 2004

(30) Foreign Application Priority Data
Mar. 17, 2003 (JP) 2003-071735

(51) Int. Cl. G01S 3/80

(52) U.S. Cl. 367/124

(57) ABSTRACT

Enables the estimation of a sound source position at an angle in a system with a small number of microphones, which was conventionally difficult to perform, and improve the precision of estimating the sound source position. By forming a reflecting surface RS as an enveloping surface of a spheroid in which a position of sound collecting means and a sound source position are the focal points, a major reflected wave having a delay amount corresponding to a sound source position is generated, and the delay amount between the direct wave and the reflected wave is checked, whereby the sound source position is acquired and estimated.

### FIELD OF THE INVENTION

The present invention relates to a sound source localization system, a sound source localization method, a sound reflecting element useful for the sound source localization system, and a method for forming the sound reflecting element. It more particularly relates to a high precision sound source localization system, a sound source localization method, a sound reflecting element useful for the sound source localization system, and a method for forming the sound reflecting element, in which the sound source position including the elevation data can be acquired with high precision even if the system comprises a smaller number of microphones.

### BACKGROUND OF THE INVENTION

Conventionally, to enhance the sound source localization performance with a microphone array, a processing system capable of making the simultaneous input for multiple channels comprising a number of microphones has been needed. This processing system allows a driving member to be controlled efficiently to face a sound source position. However, if a number of microphones are arranged to acquire the sound source position, there is an inconvenience that the total cost of the system is increased. Therefore, an attempt for reducing the number of microphones has been made. However, in the conventional attempt for reducing the number of microphones, if the number of microphones was reduced, there was an inconvenience that the information for giving a full directionality toward the sound source was lacked. Also, employing the conventional method, there was an inconvenience that the localization of the sound source was more likely to be affected by the surrounding noise, a variation in the property of sound source and the transfer characteristics of the room, although the sound source position was acquired to some extent under the conditions where the properties of the sound source were specified and the measurement environment was managed.

In the estimation of the sound source position employing a small number of microphones, various methods have been hitherto proposed. For example, a binaural hearing method employing two microphones has been well known. This method involves using a head transfer function (HRTF), measuring the head transfer function at a binaural position, disposing a sound source for generating a reference sound at various azimuths, ranges and elevations, and adding the transfer characteristics at the binaural position to acquire the positional information. The above head transfer function is obtained by deciding experimentally the transfer characteristics from the sound source to the ears, including the influences of the head, chest, and concha, for each model, but has a disadvantage of having poor universality.

Moreover, the localization of the sound source employing the above head transfer function is made by measuring the signals from the sound source, and selecting a signal consistent with an acoustic spectrum given by the head transfer function measured in advance to acquire the sound source position. Accordingly, the method employing the head transfer function allows the localization of the sound source more or less correctly in principle, if the sound source is a reference sound source. However, since the acquisition of sound source position employing the head transfer function makes the use of a dip or a peak arising in the head transfer function as a characteristic key profile, the sound source position may be possibly misjudged, when the sound source has the dip or peak. Therefore, in the present state of affairs, the acquisition of sound source position employing the head transfer function is employed more frequently in the sound reproduction than the acquisition of sound source position.

More particularly, the conventional method for acquiring the sound source position was disclosed in Okuno et al., “Are a pair of ears sufficient for robot audition?”, The journal of The Acoustical Society of Japan, vol. 58, no. 3, pages 205-210, in 2002, in which the acquisition of sound source position employing two microphones was examined. With this method, the range and azimuth are acquired, employing the ILD (Interaural Level Differences) and the ITD (Interaural Time Difference) obtained from the head transfer function. In the above acquisition of sound source position employing two microphones, the azimuth and range of the sound source can be acquired by measuring the above characteristic values from the acoustic spectrum observed. However, only with these bits of information, the range may not be acquired when the sound source for the acoustic spectrum is located in direct front.

The reason is that in, the interaural level differences and the interaural time difference are constant, even when the range is different. Also, the sound source localization method employing the interaural level differences and the interaural time difference are not effective for vertical localization.

The reason is that as long as the azimuth and range are common, the interaural time difference and the interaural level differences are common, even if the elevation varies. From the above reason, to acquire the sound source position including the range and elevation, it is considered that there is a need for taking cues on the reverberation the deformation of the acoustic spectrum, like the monaural hearing as will be described later, and also pointed out that there is a need for further examination.

Apart from the binaural hearing, an attempt for acquiring the sound source position by a method of what is called the monaural hearing has been made. The monaural hearing for localization of the sound source is similar to the manner that the man acquires the range to the sound source, in which a larger sound with less reverberation is perceived as the near sound, and a smaller sound with more reverberation is perceived as the distant sound. Employing the loudness of sound and the reverberation as described above, the range to the sound source position is roughly acquired. However, the loudness of sound depends on the sound source of object, and the level of reverberation depends on the experimental environment of acoustic spectrum as well. In the case of man, the information about the sound source of object and the environment, including the visual information, may be compensated by performing a high level information processing, and utilized to acquire the range to the sound source. This processing is practically difficult to implement on a signal processing system comprising an information processing apparatus only based on a pure routine process.

Also, in the review for the method for human to acquire the sound source position, it has been found that the azimuth and elevation to the sound source attenuates the spectrum in a specific frequency range under the influence of the head and concha. However, the acquisition method is affected by the properties of the sound source for the same reason as explained for the method employing the head transfer function, and is difficult to implement.

Regarding the use of a reflecting plate similar to the concha, a parabolic reflector for collecting a remote subtle sound has been offered by positively utilizing its reflection characteristics. FIG. 15 shows a schematic constitution of the parabolic reflector that has been offered. The parabolic reflector 100 as shown in FIG. 15 comprises a reflecting plate 102 for reflecting a sound wave 101 from a distant sound source and a microphone 104 for collecting the reflected sound wave. The reflecting plate 102 is roughly formed from a paraboloid, and the microphone 104 is disposed at a focal point position of the paraboloid. The sound wave 106 reflected from the reflecting plate 102 is focused at the focal point to efficiently collect the sound, but there is no function of acquiring the sound source position.

Moreover, in an apparatus such as a robot or a sound handling KIOSK terminal that is an object spoken to from the man, it is required to make an operation of “facing in that direction”, “turning the directivity of a microphone array to the corresponding direction” or “ignoring a distant sound”. For this purpose, it is required that the robot or apparatus recognizes the range or direction to the sound source, or the talker, and controls a drive control system to initiate a necessary operation. That is, under the conditions where the kind of signal sound is unknown, there were the disadvantages with the existing technologies that (1) one microphone does not allow the acquisition of sound source position in principle, and (2) the existing system with two microphones does not allow the acquisition of the range in the forward direction and the elevation in the vertical direction.

Also, an increased number of microphones are arranged at appropriate positions as conventionally to relieve the above limitations, whereby the acquisition precision is improved. However, due to a packaging constraint of the design cost, it is sought to relieve the above limitations with a smaller number of microphones.

As described above, there is a need for a new method and means suitable for acquiring the position of a sound source, employing an information processing system, without the use of the scale of deformation of spectrum, sound volume or intensity of reverberation needing a high level preliminary knowledge. Also, there is a further demand for a sound source localization system and a sound source localization method in which the range, azimuth and elevation to the sound source are acquired employing the above method and means. Also, there is a further need for a sound reflecting element and a design method for it in which the acquisition of sound source position is excellently made.

### SUMMARY OF THE INVENTION

In light of the above-mentioned problems associated with the prior art, an aspect of the present invention recognizes that the disadvantages of the prior art can be solved as far as the elevation information to a sound source can be analyzed with high precision, employing at least one sound collecting means, more particularly, a microphone, whereby a sound source localization system and a sound source localization method are provided with higher precision.

In an example embodiment of the present inventiom, a sound wave generated from a sound source is reflected inherently according to a sound source position, and recorded as the acoustic data collected with the direct sound. This acoustic data is converted into digital data for later processing and once held in a recording unit. The acoustic data can provide a new cue referred to as a delay deformation in this invention. Therefore, in this invention, the new scale of “delay deformation” is employed in addition to the conventional cue, without depending on the kind of signal sound source, whereby the disadvantages associated with the prior art in the acquisition of sound source position can be solved.

In another aspect, to record acoustic data the present invention provides the delay deformation with a high inherent property, this invention provides a sound reflecting element for reflecting a sound wave generated from the sound source inherently corresponding to a sound source position to enable the recording, and a processing method for processing the recorded acoustic data.

In still another asapect, according to the present invention, there is also provided a sound source localization system comprising a sound reflecting element for generating a delay deformation corresponding to a relative position between a sound source and sound collecting means, a storage part for storing the acoustic data collected via the sound reflecting element, and a sound source localization part for acquiring a sound source position, employing the acoustic data on which the delay deformation is superposed. The sound reflecting element of the invention may be formed as a spheroid associated with the relative position between the sound source and sound collecting means to generate the delay deformation intrinsic to the relative position. The sound source localization part of the invention may comprise a standard template storage part for storing a standard template containing an intrinsic delay deformation generated by a white noise sound source, a background noise template storage part for storing a background noise template, a residual generation part for calculating a residual from the acoustic data, employing the standard template and the background noise template, and a selection part for selecting the standard template giving the least residual, employing the generated residual.

In another aspect, according to the invention, there is provided a sound source localization method for acquiring the position of a sound source under the control of an information processing apparatus, the method comprising a step of collecting the acoustic data with a delay deformation superposed corresponding to a relative position between a sound source and sound collecting means, a step of storing the collected acoustic data in a storage part, and a step of reading the acoustic data with the delay deformation superposed and acquiring the relative position of the sound source designated by the delay deformation.

### BRIEF DESCRIPTION OF THE DRAWINGS

The invention and its embodiments will be more fully appreciated by reference to the following detailed description of advantageous and illustrative embodiments in accordance with the present invention when taken in conjunction with the accompanying drawings, in which:

FIG. 1 is a view showing the parameters for defining the sound source position and the position in the present invention;

FIG. 2 is a view for explaining an essential principle for generating a delay deformation in this invention;

FIG. 3 is a view for explaining an essential principle for forming a reflecting surface of a sound reflecting element in this invention;

FIG. 4 is a view schematically showing the reflection of sound wave on the reflecting surface as shown in FIG. 3;

FIG. 5 is a view showing the envelope for forming the cross-sectional shape of the sound reflecting element formed in this invention;

FIG. 6 is a view showing the sound reflecting elements according to an embodiment of the invention;

FIG. 7 is a view showing an arrangement of sound reflecting elements according to the embodiment of the invention;

FIG. 8 is a schematic flowchart showing a sound source localization method of the invention;

FIG. 9 is a block diagram showing the schematic configuration of a sound source localization system of the invention;

FIG. 10 is a block diagram showing the detailed configuration of the sound source localization part of the invention;

FIG. 11 is a view showing a standard template and the storage of three-dimensional position coordinates according to the embodiment of the invention;

FIG. 12 is a graph showing a delay deformation obtained in this invention;

FIG. 13 is a graph showing the correlation between the delay deformation generated in the invention and the delay deformation on design;

FIG. 14 is a diagram showing the precision of sound source position acquired in this invention; and

FIG. 15 is a view showing the schematic configuration of a conventional parabolic reflector.

### DESCRIPTION OF SYMBOLS

10 . . . sound reflecting element

12 . . . sound collecting means (microphone)

14 . . . plane

16 . . . imaginary line

18 . . . sound reflecting element

20 . . . talker

22 . . . sound reflecting element

24 . . . recording part

26 . . . sound source localization part

28 . . . driving element

30 . . . acoustic data storage part

32 . . . STP storage part

34 . . . BNT storage part

36 . . . PF part

38 . . . residual storage part

40 . . . selection part

42 . . . application execution part

### DETAILED DESCRIPTION OF THE INVENTION

The present invention provides methods, systems and apparatus for solving problems associated with the prior art. The present invention recognizes that the disadvantages of the prior art can be solved as far as the elevation information to a sound source can be analyzed with high precision, employing at least one sound collecting means, more particularly, a microphone, whereby a sound source localization system and a sound source localization method are provided with higher precision.

In an example embodiment of the present inventiom, a sound wave generated from a sound source is reflected inherently according to a sound source position, and recorded as the acoustic data collected with the direct sound. This acoustic data is converted into digital data for later processing and once held in a recording unit. The acoustic data can provide a new cue referred to as a delay deformation in this invention. Therefore, in this invention, the new scale of “delay deformation” is employed in addition to the conventional cue, without depending on the kind of signal sound source, whereby the disadvantages associated with the prior art in the acquisition of sound source position can be solved.

To record the acoustic data by providing the delay deformation with a high inherent property, this invention provides a sound reflecting element for reflecting a sound wave generated from the sound source inherently corresponding to a sound source position to enable the recording, and a processing method for processing the recorded acoustic data.

According to the present invention, there is also provided a sound source localization system comprising a sound reflecting element for generating a delay deformation corresponding to a relative position between a sound source and sound collecting means, a storage part for storing the acoustic data collected via the sound reflecting element, and a sound source localization part for acquiring a sound source position, employing the acoustic data on which the delay deformation is superposed. The sound reflecting element of the invention may be formed as a spheroid associated with the relative position between the sound source and sound collecting means to generate the delay deformation intrinsic to the relative position. The sound source localization part of the invention may comprise a standard template storage part for storing a standard template containing an intrinsic delay deformation generated by a white noise sound source, a background noise template storage part for storing a background noise template, a residual generation part for calculating a residual from the acoustic data, employing the standard template and the background noise template, and a selection part for selecting the standard template giving the least residual, employing the generated residual. The standard template storage part of the invention may store the standard template and the sound source position giving the standard template in association. The sound source localization system of the invention may comprise one or more sound reflecting elements, and simultaneously acquires the positional data of the sound source including a range to the sound source, an azimuth and an elevation as the relative position.

According to the invention, there is provided a sound source localization method for acquiring the position of a sound source under the control of an information processing apparatus, the method comprising a step of collecting the acoustic data with a delay deformation superposed corresponding to a relative position between a sound source and sound collecting means, a step of storing the collected acoustic data in a storage part, and a step of reading the acoustic data with the delay deformation superposed and acquiring the relative position of the sound source designated by the delay deformation. The delay deformation of the invention may be generated by reflection from a spheroid associated with the relative position between the sound source and sound collecting means, and the delay deformation may be generated intrinsic to the relative position. The sound source localization step of the invention may comprise a step of reading out a standard template from a standard template storage part for storing the standard template containing a delay deformation intrinsic to the relative position generated by a white noise sound source, a step of reading out a background noise template from a background noise template storage part for storing the background noise template, a step of calculating a residual from the acoustic data, employing the standard template and the background noise template, and a step of selecting the standard template giving the least residual, employing the generated residual. The selection step of the invention may comprise a step of referring to the selected standard template and acquiring the sound source position corresponding to the standard template. The sound source localization method of this invention may further comprise a step of simultaneously acquiring the range, azimuth and elevation as the relative position from the acquired sound source position to the sound source.

According to the invention, there is provided a sound reflecting element for generating a delay deformation corresponding to a relative position between a sound source and sound collecting means, wherein a reflecting surface of the sound reflecting element is designed as an envelope made from a plurality of spheroids that are formed by rotating a plurality of ellipses having the two focal points corresponding to the sound source and the sound collecting mean around an axis connecting the focal points.

The plurality of ellipses in this invention may be generated in relation with the elevation between the sound source and the sound collecting means and flatter as the elevation is greater. The reflecting surface in this invention may be designed as an enveloping surface of the plurality of spheroids that are generated by rotating a corresponding ellipse around the axis connecting the focal points.

According to the invention, there is provided a formation method of a sound reflecting element for generating a delay deformation corresponding to a relative position between a sound source and sound collecting means, the method comprising a step of generating a plurality of spheroids by rotating an ellipse having the focal points corresponding to the sound source and the sound collecting mean around an axis connecting the focal points, and a step of forming a reflecting surface by generating an enveloping surface of the plurality of spheroids. The plurality of ellipses in this invention may be generated in relation with the elevation between the sound source and the sound collecting means and flatter as the elevation is greater.

A. Constitution of Sound Reflecting Element

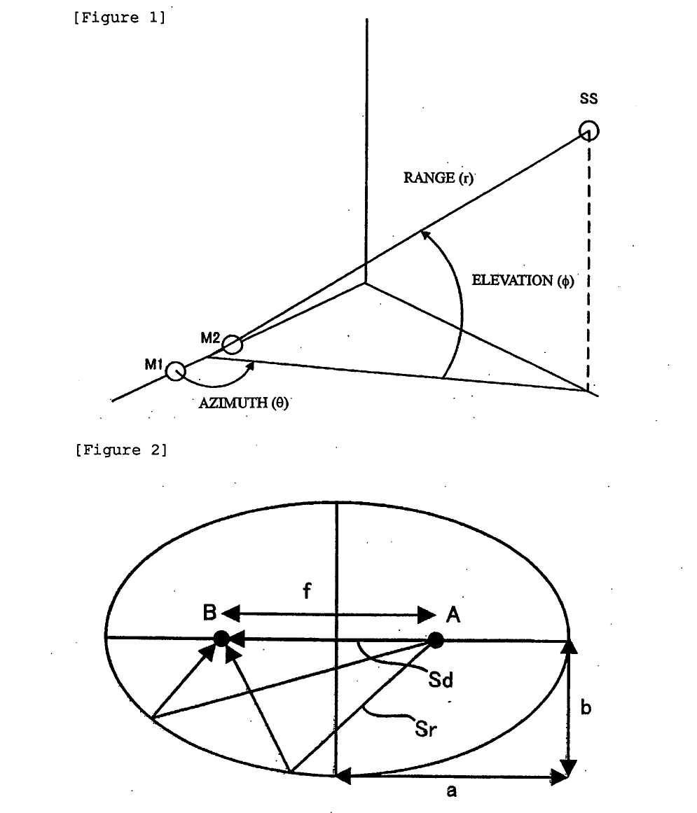

FIG. 1 is a view showing the definition of the range, azimuth and elevation for use in the present invention. In FIG. 1, the microphones M1 and M2 as sound collecting means are employed, in which the azimuth, range and elevation are represented as the position coordinates measured from a middle point between the microphones M1 and M2. A sound source SS is separated away by a predetermined range r from the middle point between the microphones. In the above coordinates, the sound source position can be represented in the Cartesian coordinate system (x, y, z) or polar coordinate system (r, θ, φ) in this invention. In the following, the acquisition of elevation is explained as a specific embodiment in this invention, but the invention is applicable to the acquisition of any sound source position collected in the scale of angle and range, in addition to the azimuth and elevation.

This invention essentially involves a path difference between the sound wave directly collected from the sound source and the reflected wave reflected from a reflecting surface of the sound reflecting element, such that the shape of sound reflecting element is configured to relate the position of sound source with the path difference. In the invention, the sound reflecting element is configured essentially as a set of elliptic curves. Conventionally, for an elliptic curved surface, it is well known that the sound wave produced from one focal point of the ellipse is reflected to the other focal point. FIG. 2 shows the typical properties of the ellipse. As shown in FIG. 2, the cross section of the reflecting surface is configured using the ellipse in which the sound source is disposed at one focal point A and the microphone is disposed at the other focal point B in this invention. In an arrangement as shown in FIG. 2, a sound wave Sr starting from the focal point A is collected at the same focal point B, even if reflected at any position on the wall. Employing the ellipse as the reflecting surface, it follows that the reflected wave always has a certain path difference (2a-f) as defined by the elliptic curve from a sound wave Sd not reflected and directly going from the focal point A to the focal point B.

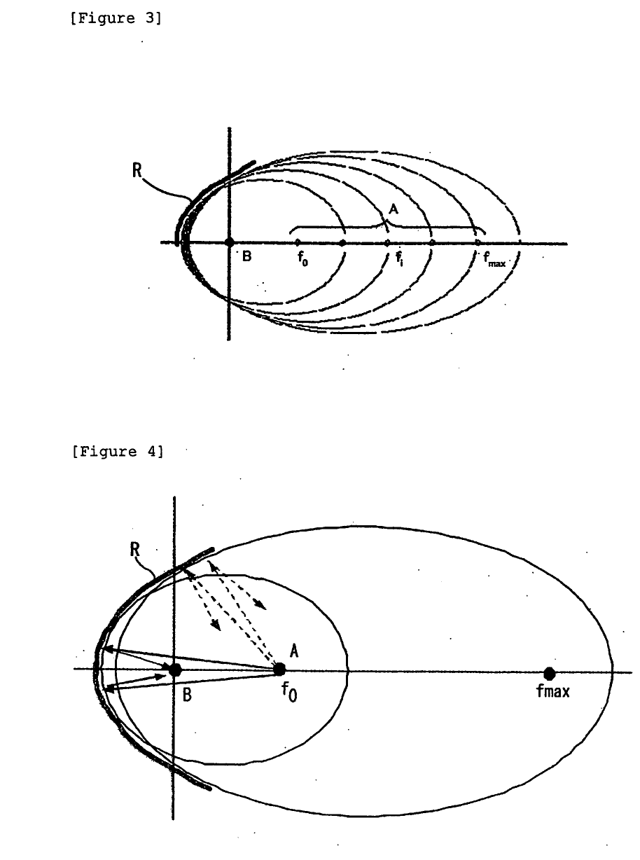

Taking notice of the path difference, it was reviewed to positively utilize the path difference for the localization of the sound source in this invention. Herein, considering an application mode of the realistic sound reflecting element in the acquisition of sound source position, it is important in the realistic configuration that the microphone is fixed relative to the sound reflecting element, and the sound source such as a talker is moved. Thus, the properties of the reflecting surface are examined, when the position of the microphone is fixed at one focal point B, and the position of the focal point A is changed to have the position of the sound source at the other focal point A. In FIG. 3, the maximum range for judging the position of the sound source is defined, and the noise is judged as beyond the maximum range. In FIG. 3, the sound source is moved from the supposed farthest position fₘₐₓ to the supposed nearest position fₒ. At the same time, the shape R of an envelope for the ellipses with the focal points fₘₐₓ and fₒ is shown when the sound source is moved from the supposed farthest position fₘₐₓ to the supposed nearest position fₒ in FIG. 3. As shown in FIG. 3, when the focal point A (sound source position) is closer to the microphone, the ellipse has a rounded shape similar to the circle, or when the focal point A (sound source position) is far away from the microphone, the ellipse has a collapsed shape. Also, as the focal point A is farther, the left end shape approximates asymptotically the parabola. In this invention, the shape of sound reflecting element is essentially configured as the envelope of elliptic curves that are formed in connection with the movement of sound source position.

FIG. 4 is a view schematically showing the reflection of sound wave from the sound source position A, when the reflecting surface is configured as the shape of envelope as shown in FIG. 3. As shown in FIG. 4, when the sound wave from the nearer sound source position is reflected at a rear portion of the elliptic curve, its reflected wave is collected at the focal point B that is the microphone position. On the other hand, when reflected near an end portion of the elliptic curve, the sound wave is diffused because the angle is not consistent. Therefore, a major portion of the reflected wave detected is occupied by the wave reflected at the rear portion of the sound reflecting element. Similarly, for another sound source position, it has been found that the reflection position to make a major reflected wave component in accordance with its sound source position is generated when the reflecting surface R of sound reflecting element is configured from the envelope. That is, in this invention, it has been found that the major reflected wave intrinsic to the sound source position is generated when the sound reflecting element is formed with the reflecting surface containing the enveloping surface of ellipses. On the other hand, a path difference between the major reflected wave and the direct wave is accompanied with a delay time, which is equivalent to the path difference as defined by the corresponding ellipse.

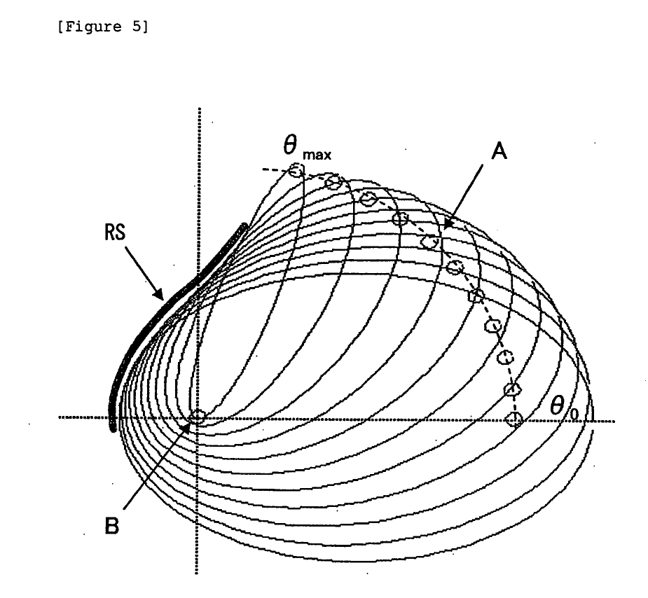

Moreover, the present inventors have reviewed the elevation determination when the envelope of ellipses is employed as the reflecting surface. FIG. 5 shows an envelope of elliptic curves and a shape RS of sound reflecting element corresponding to the envelope when the range between the microphone position B and the sound source position A is set at the designed value, and the elevation θ is changed from the supposed lowest angle θ₀ to the supposed highest angle θₘₐₓ. As explained in FIG. 4, if the sound reflecting element RS is formed by the envelope, the sound wave from the sound source at low angle has its major reflected wave reflected at the bottom portion of the sound reflecting element, while the sound wave from the sound source at high angle has its major reflected wave reflected at the top portion of the sound reflecting element. This major reflected wave is accompanied with a delay time corresponding to the path difference defined by the corresponding ellipse. That is, the reflected wave intrinsically corresponds to the sound source position.

Though this invention has been described above in detail in connection with the cross-sectional shape of the reflecting surface, the shape of the sound reflecting element of the invention is required to be provided in the three dimensions in reality. In this invention, the three-dimensional shape of the reflecting surface of the sound reflecting element for reflecting the sound wave can be formed as the enveloping surface of a plurality of spheroids produced by rotating the corresponding ellipse around an axis connecting the focal point on the side where the microphone is placed and the focal point where the sound source position is located.

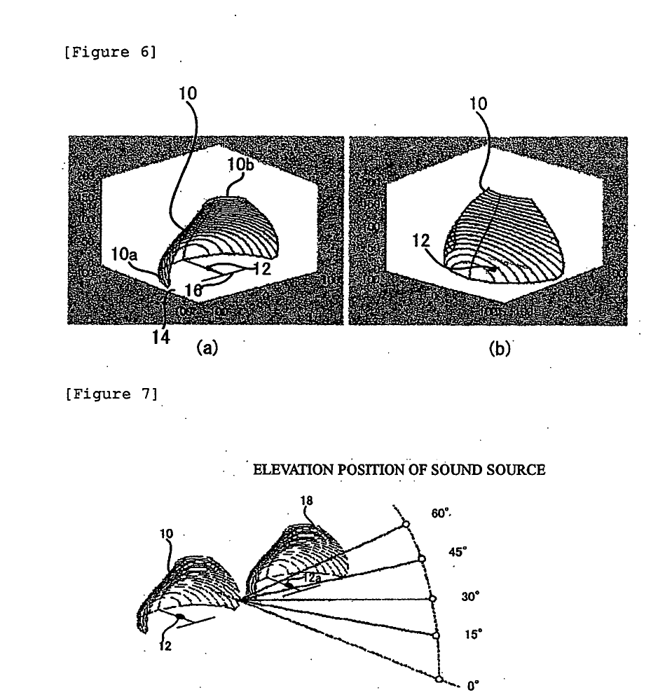

FIG. 6 shows a specific embodiment of the sound reflecting element that is configured according to the invention. For the sound reflecting element 10 of the invention as shown in FIG. 6, the tangential line with each spheroid corresponding to the sound source position is also shown to easily recognize the shape. As shown in FIG. 6, the sound reflecting element 10 of this invention is configured by cutting the enveloping surface of the spheroid into a size easily employed. FIG. 6A is a perspective view of the sound reflecting element 10 as seen from the side of a concave face, and FIG. 6B is a perspective view of the sound reflecting element 10 as seen from the side of a convex portion. As shown in FIG. 6, the sound reflecting element 10 of the invention has a bottom portion 10a composed of an ellipsoid having a large eccentricity and an upper end portion 10b composed of an ellipsoid having an increased eccentricity, and is narrowed toward the upper end portion 10b in accordance with the elevation.

In the sound reflecting element 10 of the invention, the microphone 12 is disposed at one common focal point of the spheroid making up the sound reflecting element 10. Also, the microphone 12 is disposed at a position symmetrical to the sound reflecting element 10 on a plane 14 containing the bottom portion 10a. In the embodiment as shown in FIG. 6, the position of the microphone 12 is located on the side of the sound reflecting element 10 above an imaginary line 16 connecting the transverse ends of the sound reflecting element 10. However, it may take any position as far as the reflected wave from the sound reflecting element 10 is received uniformly with the noise suppressed in this invention. Also, the sound reflecting elements 10 of the invention may be connected vertically with the plane 14 as the boundary.

FIG. 7 is a perspective view showing an arrangement of the sound reflecting element 10 according to the embodiment of the invention. In the arrangement as shown in FIG. 7, the sound reflecting elements 10 and 18 are disposed as one pair. The sound reflecting elements 10 and 18 have the microphones 12 and 12a disposed in the same configuration as shown in FIG. 6. Moreover, in the arrangement of the sound reflecting element as shown in FIG. 7, the sound reflecting elements 10 and 18 are faced in the same direction and suitable for acquiring the sound source position in the direction where the concave portions of the sound reflecting elements 10 and 18 are opposed. The sound reflecting element of the invention can essentially acquire the elevation of the sound source position, employing one sound reflecting element, but employing the sound reflecting elements as one pair as shown in FIG. 7, the range, elevation and azimuth to the sound source position may be decided simultaneously.

Also, if the overall shape of the sound reflecting element is designed to be small, the path difference between the direct wave and the major reflected wave is shortened. To observe its influence precisely, a high sampling frequency is required. In the specific embodiment of the invention, when the elevation to the sound source is 0° and 72°, and if the path difference between the direct wave and the major reflected wave is about 9.5 cm, a delay time difference of about 0.28 ms is produced. When the sampling frequency is 48 KHz, this delay time is equivalent to a difference of about thirteen samples. That is, theoretically, it follows that the elevation to the sound source has a maximum resolution of 13 levels to discriminate the elevation from 0° to 72°. In this invention, if the overall shape is designed to be half in size while keeping the resolution, it is required that the sampling frequency is doubled to 96 KHz. Also, if the overall size of the shape is designed to be double, the same resolution is attained even when the sampling frequency is halved or 24 KHz.

B. Sound Source Localization Method and System of the Invention

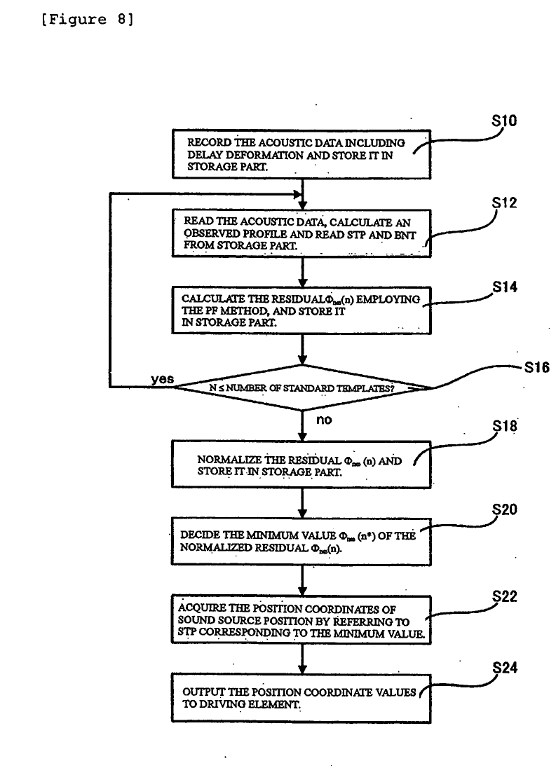

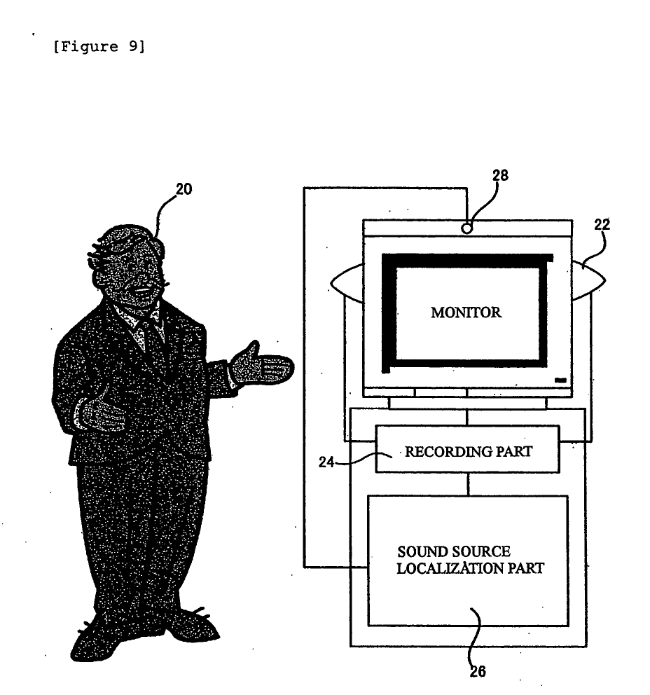

FIG. 8 is a schematic flowchart of a sound source localization method according to the invention. In the sound source localization method of the invention as shown in FIG. 9, the acquisition of elevation is made employing the sound reflecting element as explained in the section A. In the sound source localization method of the invention as shown in FIG. 8, at step S10, the acoustic data such as voice data is collected via the sound reflecting element from the microphone, converted into digital data, employing an AD converter and stored in memory. At step S12, an observed profile is calculated from the acoustic data in accordance with a method as disclosed in detail in “Speech Enhancement by profile fitting method”, O. Ichikawa et al., IEICE Transactions on Information and System, VoL. E86-D, No. 3, pp. 514-521, March 2003, and at the same time, a standard template (STP) and a background noise template (BNT) that are stored in respective storage parts are read out. At step S14, a residual Φ_{n,ω} between the observed profile and a linear combination of the standard template and the background noise template is calculated, and stored in an appropriate memory.

At step S16, it is determined whether or not there is left any standard template to be further read out. In this manner, the residuals are calculated for all the standard templates. Then, at step S18, the residual Φ_{n,ω} is normalized for each subband frequency, and stored in memory. At step S20, the minimum value of the normalized residuals Φ_{n,ω} is decided. Then, at step S22, the sound source position corresponding to the standard template giving the minimum value of the calculated residuals is acquired, and selected as the sound source position. At step S24, the coordinates of the sound source position registered corresponding to the selected sound source position are output in an appropriate format to the driving element for controlling the acquired sound source position.

As the method for calculating the residual in this invention, a profile fitting method (hereinafter referred to as a PF method) is applied. Particularly in the preferred embodiment of the invention, the PF method is desirably employed. The PF method is a noise suppression method as disclosed in “Speech Enhancement by profile fitting method”, O. Ichikawa et al., IEICE Transactions on Information and System, VoL. E86-D, No. 3, pp. 514-521, March 2003, whereby the noise is removed, employing the observed profile from the sound source where the elevation, azimuth and range are defined. However, the PF method is also appropriately employed for a process for estimating the sound source position in this invention.

The observed profile for use in a process of the specific embodiment of the invention means a power distribution at each subband frequency that is observed by processing an audio signal recorded by the microphone with a delay sum array, and allocating the angle of directivity of the delay sum array from the maximum value to the minimum value. In this invention, the standard template means a template profile normalized in the area from a two-dimensional observed profile including the delay deformation recorded via the sound reflecting element employed in the invention and measured in advance for a white noise sound source at the known position in which the direction of allocating the angle of directivity is taken along the axis of abscissas and the power is taken along the axis of ordinates.

Also, the background noise template in this invention means a template profile normalized in the area from an acoustic profile observed by placing a white noise sound source at the noise sound source position, in which the width of allocating the angle of directivity is given according to the number of sampling channels. In creating the standard template and the background noise template, it is desirable to employ the white noise having a power over the entire frequency band, as previously described. However, the signal and the noise to be actually observed may be employed to approximate the white noise.

Moreover, the residual Φ_{n,ω} of the invention is given by the following formula.

$$[ Formula 1 ] \\ {Φ}_{n , ω} = {\int }_{min\_θ}^{max\_θ} {( {X}_{ω} ( θ ) - {α}_{n , ω} \cdot {P}_{n , ω} - {β}_{n , ω} \cdot {Q}_{ω} ( θ ) \}}^{2} ⅆ θ . \qquad ( 1 )$$

In the above expression, X₁₀₇ (θ) is the power at the subband frequency ω in which the audio signal with a delay deformation superposed through the sound reflecting element of the invention is processed with the angle of directivity of the delay sum array in the θ direction, and here called the observed profile. P_{n,ω} (θ) is the template profile stored as the standard template corresponding to the sound source position, and Q_{ω} (θ) is the template profile stored as the background noise template. Also, n corresponds to the sound source position.

When the PF method is employed for the sound enhancement, the component decomposition should be made for each frame.

However, for the sound source localization, the component decomposition should be made once for the average over all the audio frames to allow the acquisition of sound source position. So, X_{ω} (θ) may be the average of speaking utterances for several seconds. If α_{n,ω} and β_{n,ω} are decided using the above formula, the residual Φ_{n,ω} is obtained. Moreover, the normalized residual bar_Φ_{n,ω} is calculated by dividing Φ_{n,ω} by the power for each subband and averaging over Ω subbands as defined by the following formula.

$$[ Formula 2 ] \\ {bar\_Φ}_{n} = \frac{1}{Ω} {Σ}_{ω} \frac{{Φ}_{n , ω}}{{\int }_{min\_θ}^{max\_θ} \{ {{X}_{ω} ( θ )}^{2} ⅆ θ} \qquad ( 2 )$$

Also, the acquisition of sound source candidate position is made by selecting a sample template sound source candidate position hat_n so that the normalized residual may be the minimized, and selecting the acquired sound source position, using the following formula (3).

[Formula 3]

hat_{—}n=argₙmin(bar_Φₙ) (3)

An index of “profile” as used in this invention contains not only the cue of delay deformation for the acoustic spectrum, but also the cues of the interaural time difference and the interaural level differences as conventionally employed. That is, the method of the invention not only detects the delay deformation, but also makes it possible to employ the cues of the interaural time difference and the interaural level difference as conventionally employed, together with the cue of delay deformation. Therefore, in this invention, the range, azimuth and elevation required for the acquisition of sound source position can be acquired simultaneously. Accordingly, in the invention, the process for acquiring the sound source position is performed seamlessly, employing a smaller number of microphones than conventionally needed, and the availability of the sound source localization system is expanded. That is, the acquisition of elevation, which was conventionally impossible with the sound source localization method employing as few as one or two microphones, is not dealt with exceptionally, but is processed at the same time with the case of acquiring the angle in the horizontal direction which was conventionally allowed, whereby the process is performed faster. Also, the cue of delay deformation with the sound reflecting element is added to the case for acquiring the angle which was conventionally allowed, whereby the higher precision localization is allowed.

FIG. 9 is a view showing the schematic configuration of the sound source localization system according to a specific embodiment of the invention. The sound source localization system of this invention comprises a sound reflecting element 22 for collecting and recording voices from the talker 20, a recording part 24 for converting the acoustic data recorded in the sound reflecting element 22 into digital data and storing it, and a sound source localization part 26 for acquiring the sound source position by analyzing the acoustic data. The acquired sound source position information is passed to an application execution part, not shown, in an appropriate format of the coordinates of sound source position such as the Cartesian coordinates (x, y, z) or the polar coordinates (r, θ, φ) that is decided employing the registered standard template.

The application execution part receives an input of position coordinates and drives the driving element 28 needed in the specific embodiment. The driving element 28 may be a head, a hand, a foot, an eye, a mouth, the body, a leg, or the whole body for the robot, a camera or a microphone for the kiosk apparatus, or a microphone or a camera for a security system. However, the invention is not limited to the above driving elements.

Also, the sound source localization system of the invention is implemented as an information processing apparatus roughly comprising a CPU (Central Processing Unit), a memory, an external I/O control device, a modem and an NIC. Moreover, the sound source localization system of the invention is mounted on the apparatus comprising the driving element for the robot being driven by application software, in which a predetermined position of the driving element is controlled and driven by comparing a range difference, an azimuth difference and an elevation difference between the original position and the acquired sound source position.

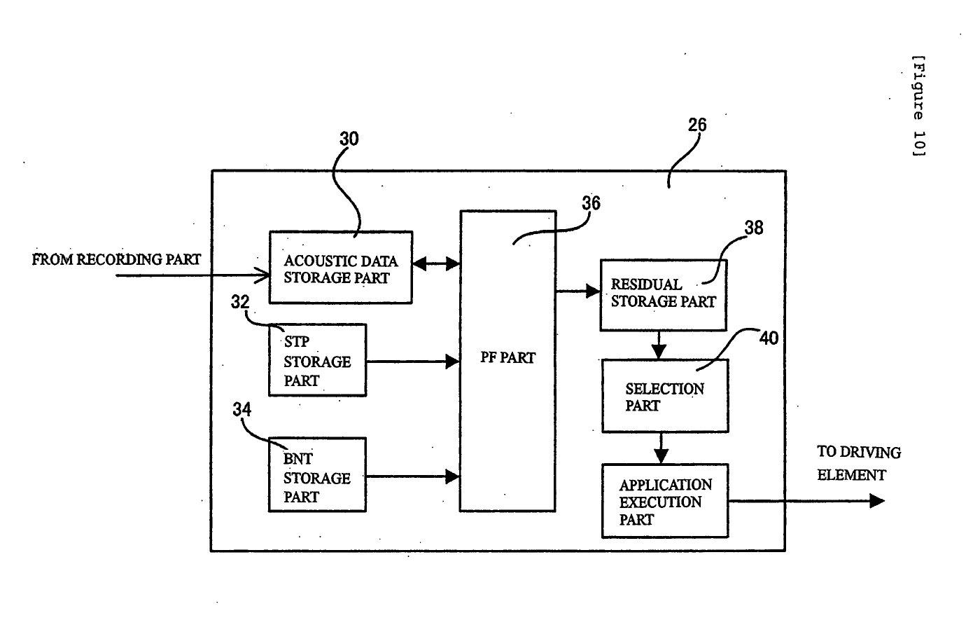

FIG. 10 is a detailed functional block diagram showing the functional configuration of a sound source localization part 26 included in the sound source localization system of the invention. The sound source localization part 26 shown in FIG. 10 is realized by a program executing the sound source localization method that is mounted on the robot, kiosk, cache dispenser, a security device for making an operation by sensing a sound, the program being executed by the CPU to function as each means as mentioned above. As shown in FIG. 10, the sound source localization part 26 of the invention comprises an acoustic data storage part 30 for reading out the acoustic data once stored in the recording part as the digital data by the sound reflecting element 22, and storing it for processing, a standard template (STP) storage part 32, and a background noise template (BNT) storage part 34.

Moreover, the sound source localization part 26 of the invention comprises a profile fitting (PF) part 36 for calculating the residual, a residual storage part 38 for storing the residual Φ_{n,ω} obtained by the PF part 36, a selection part 40 for selecting the standard template giving the minimum residual from the normalized residual, and an application execution part 42 for executing a necessary application.

The PF part 36 of the invention reads in the acoustic data, converts it into an observed profile, then reads out the standard template from the STP storage part 32, and reads out the background noise template from the BNT storage part 34. The PF part 36 calculates a residual between the linear combination of templates and the observed profile, its result being registered in the residual storage part 38. Moreover, the sound source localization part 26 specifies the normalized residual giving the minimum residual in the selection part 40 by normalizing the residual stored in the residual storage part 38 and comparing the normalized residuals. Thereafter, the three-dimensional position stored by referring to the standard template giving the corresponding residual is acquired as an appropriate format.

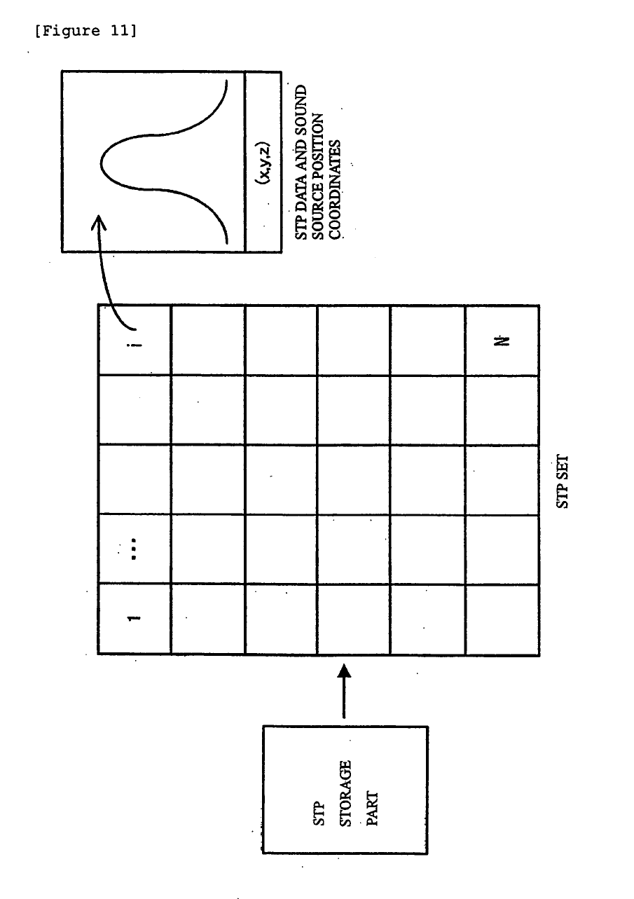

FIG. 11 is a diagram schematically showing the standard template stored in the STP storage part 32 and the data structure of position coordinates in this invention. The STP storage part 32 is assigned with a memory area corresponding to the three-dimensional position (1, . . . , N: N is a positive integer, corresponding to the total number of standard templates). In each memory area i, the STP data and the three-dimensional position data (x, y, z) are stored in association with respective addresses. In another embodiment of the invention, the standard template and the three-dimensional position data may be stored in different memory areas to be referenced from each other.

As shown in FIG. 11, in the memory area i, the STP data and the three-dimensional position data are stored in association. If the acoustic data is input, the PF part 36 converts it into an observed profile, accesses the memory area i in succession to read out the standard template, calculates the linear combination employing the BNT data, and computes the residual between its value and the observed profile, the result being output to the residual storage part 38. In this invention, a delay deformation defined by the sound reflecting element employed in the invention is introduced into the STP data stored in the STP storage part 32, whereby the elevation is given the intrinsic delay deformation and acquired with high precision. The selection part 40 refers to the memory area i giving the minimum residual, and reads out the three-dimensional position data (x, y, z) stored in the memory area i to acquire the sound source position. The acquired three-dimensional position data is made a control input into the application execution part 42 to control the driving of the driving element 28, as shown in FIG. 11.

### EXAMPLE EMBODIMENTS

Specific embodiments of the invention will be described below by way of example, but the invention is not limited to the following examples.

### Example 1

### Sound Reflecting Element for Acquiring the Elevation in the Forward Direction

Assuming that the azimuth of a sound source candidate position was 90° (forward direction), the range to a sound source was 2 m, and the acquirable elevation was from 0° to 72°, an enveloping surface of the spheroid was produced as the sound reflecting element. An upper end portion of the sound reflecting element formed in Example 1 reflects a sound wave from the sound source position at high elevation to converge into the microphone position and a portion near the root of the sound reflecting element reflects a sound wave from the sound source position at low elevation to converge into the microphone position. On the other hand, the sound wave from other sound source positions is diffused. If the reflecting position is different, a stroke difference from the direct wave is also varied, generating a proper reflected wave with a delay amount corresponding to the sound source position added.

In the case in which the sound reflecting element was employed, there was a delay time difference of about 0.28 ms (milliseconds) in the path difference between the direct wave and the major reflected wave, when the elevation to the sound source was 0° and 72°. The sound source localization system was composed of the sound reflecting element, the microphone, the AD converter, and the microcomputer, whereby the precision of the acquired sound source position was examined. The sampling frequency of the sound source localization system was 48 KHz, and the elevation resolution in which the elevation to the sound source was from 0° to 72° was made discernable at 13 levels at maximum.

### Example 2

### Confirmation for Generating a “Delay Deformation” in the Sound Reflecting Element

The sound reflecting elements formed in Example 1 were disposed as shown in FIG. 7, and had two microphones attached to form a sound collecting recording part of the invention. For the input, the voices were used, speakings “there” and “hello” for several seconds were regenerated from the sound source position in the forward direction and with the range 2 m and the elevation 0°, 15° 30°, 45° and 60°, whereby an observed profile was produced as the input voice. At this time, the sampling frequency was 48 KHz. To confirm the existence of reflected wave having delay deformation of the invention, one of the analysis methods of high sensitivity, CSP (Cross-power Spectrum Phase analysis) method by M. Omologo et al. (“Acoustic event localization using a cross power-spectrum phase based technique.”, proc. ICASSP 94, pp. 273-276, 1994.) was employed.

The CSP method, which traces the acoustic signal at high sensitivity, can give the delay deformation at high sensitivity in this invention. For the sound source at an elevation of 30°, the calculated CSP coefficients will be shown. Since the CSP method generates a number of pseudo peaks, it is optional how small sub-peak relative to the main peak should be regarded as the valid peak, unlike the main peak. At present, the peaks having one-tenth or more the intensity of the main peak and upper intensities to the third were set as the effective peak.

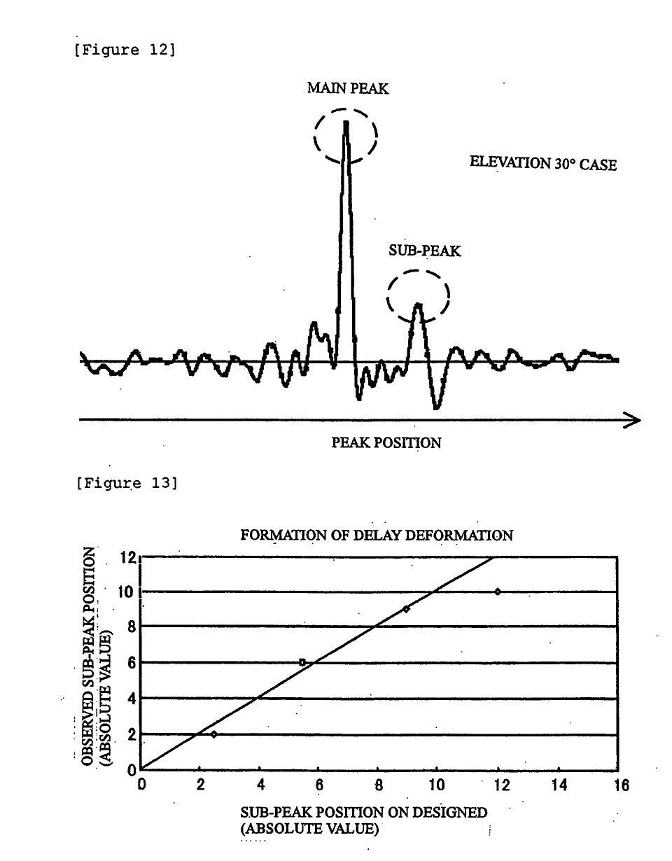

FIG. 12 shows the CSP coefficients obtained from the input sound signal for the sound source having an elevation of 30°. The results are shown in Table 1.

TABLE 1

| Elavation of sound | | | | | |
|---|---|---|---|---|---|
| source→ | 0° | 15° | 30° | 45° | 60° |
| First place peak | 0 | 0 | 0 | 0 | 0 |
| position | | | | | |
| Second place peak | N/A | 10 | 9 | 6 | 2 |
| position | | | | | |
| Third place peak | N/A | N/A | N/A | −6 | — |
| position | | | | | |
| Sub-peak position | ±14 | ±12 | ±9 | ±5.5 | ±2.5 |
| expected on design | | | | | |

Table 1 Peak positions detected by CSP method (unit: number of samples)

The peak position having the first place intensity corresponds to the direct wave, in which the peak position 0 indicates that the sound source is disposed in the direct front. At the second place and third place peaks, it is expected that two sub-peaks due to correlation between the direct wave and the reflected wave are detected at the position of designed point as indicated in the table. In Example 2, at least one sub-peak having significant intensity was detected in the cases except for 0° as indicated in the table 1. Also, the delay deformation for the sound source position was detected by detecting the existence of the expected sub-peak to correspond to the designed point. In the case of the sound source elevation of 0°, the expected sub-peak position was not detected. The reason is that the sound reflecting element formed in Example 1 has a reflection area of zero designed for an elevation of 0° (the root of the sound reflecting element)

FIG. 13 shows a correlation between the sub-peak position obtained in Example 2, and the sub-peak position expected on design. As shown in FIG. 13, the observed sub-peak position has the fine correlation with the existing position of the reflected wave expected in the sound reflecting element of Example 1. From the result of FIG. 13, it is found that the sound reflecting element formed in Example 1 gives an expected delay deformation.

### Example 3

Employing the sound reflecting element formed in Example 1, an examination was made to determine whether or not the elevation of sound source could be practically acquired correctly. For the acquisition of sound source position using the delay deformation, the PF method was employed in this Example 3. A white noise was regenerated from a noise sound source at a horizontal angle 75°, a range 1 m, and an elevation 0° to simulate the background noise. The speaking utterances and the sound levels from five positions were produced by changing the elevation, with the background noise superposed, to create the test voices. Employing the following formula, the score was defined from the view point of what difference is provided for the second best candidate, whereby the precision of acquiring the elevation position was examined. Where n* is an identifier of the standard template corresponding to the correct position, and the residual Φₙ* is the normalized residual at the correct position.

$$\begin{matrix}[ Formula 4 ] \\ ρ = \frac{{bar\_Φ}_{bar\_n} - {bar\_Φ}_{n}^{*}}{{bar\_Φ}_{bar\_n}} & ( 4 ) \\ [ Formula 5 ] \\ bar\_n = {arg min}_{n \neq {n}^{*}} ( {bar\_Φ}_{n} ) & ( 5 )\end{matrix}$$

The above score is given 100% if the normalized residual is zero when the profile corresponding to the correct sound source candidate position is selected, and given 0% or less when the acquisition of sound source candidate position fails, because the normalized residual for another profile has the minimum value.

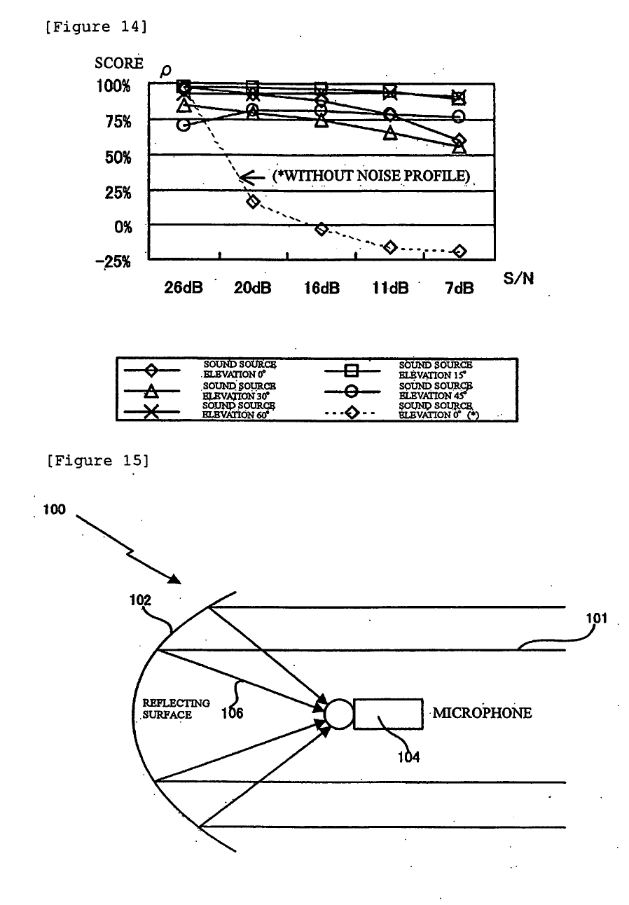

In Example 3, the averaging operation of the sub-band when calculating the normalized residual was made in a range from 985 Hz to 7504 Hz where the influence of the sound reflecting element is most apparent. The results obtained are shown in FIG. 14. As shown in FIG. 14, in any case, one correct sound source candidate position can be selected from among the five candidate positions by exploiting the component decomposition by the PF method, without being affected by the noise. Also, in this invention, when the background noise template is not employed, the score are decreased with the decrease of the S/N ratio. In this invention, the acquisition of sound source position is made with high precision regardless of the S/N ratio by incorporating the background noise template for the residual calculation.

Though this invention has been described above by way of example, the invention is not limited to the above described examples. It will be understood to those skilled in the art that various changes and exclusions, and other examples may be made. Also, the sound source acquisition method of the invention can be described in any programming language as ever known, in which these languages include C, C++, Assembler and machine language. Also, the program that can be executed by the computer to perform the sound source acquisition method of the invention may be stored in ROM, EEPROM, flash memory, CD-ROM, DVD, flexible disk, or hard disk and distributed.

What is claimed, is:

1) A sound source localization system comprising:
a sound reflecting element for generating a delay deformation corresponding to a relative position between a sound source and sound collecting means;
a storage part for storing the acoustic data collected via said sound reflecting element; and
a sound source localization part for acquiring a sound source position, employing the acoustic data on which said delay deformation is superposed.

2) The sound source localization system according to claim 1, wherein said sound reflecting element is formed as a spheroid associated with the relative position between the sound source and sound collecting means to generate said delay deformation intrinsic to said relative position.

3) The sound source localization system according to claim 1, wherein said sound source localization part comprises a standard template storage part for storing a standard template containing an intrinsic delay deformation generated by a white noise sound source, a background noise template storage part for storing a background noise template, a residual generation part for calculating a residual from said acoustic data, employing said standard template and said background noise template, and a selection part for selecting the standard template giving the least residual, employing the generated residual.

4) The sound source localization system according to claim 3, wherein said standard template storage part stores the standard template and the sound source position giving said standard template in association.

5) The sound source localization system according to claim 1, wherein said sound source localization system comprises at least one sound reflecting element, and simultaneously acquires positional data of the sound source including a range to the sound source, an azimuth and an elevation as said relative position.

6) A sound source localization method for acquiring the position of a sound source under the control of an information processing apparatus, said method comprising:
a step of collecting the acoustic data with a delay deformation superposed corresponding to a relative position between a sound source and sound collecting means;
a step of storing said collected acoustic data in a storage part; and
a step of reading the acoustic data with said delay deformation superposed and acquiring said relative position of said sound source designated by said delay deformation.

7) The sound source localization method according to claim 6, wherein said delay deformation is generated by reflection from a spheroid associated with said relative position between the sound source and sound collecting means, and said delay deformation is generated intrinsic to said relative position.

8) The sound source localization method according to claim 6, wherein said sound source localization step comprises a step of reading out a standard template from a standard template storage part for storing the standard template containing a delay deformation intrinsic to said relative position generated by a white noise sound source, a step of reading out a background noise template from a background noise template storage part for storing the background noise template, a step of calculating a residual from said acoustic data, employing said standard template and said background noise template, and a step of selecting the standard template giving the least residual, employing the generated residual.

9) The sound source localization method according to claim 6, wherein said selection step comprises a step of referring to the selected standard template and acquiring the sound source position corresponding to said standard template.

10) The sound source localization method according to claim 6, further comprising a step of simultaneously acquiring the range, azimuth and elevation as said relative position from said acquired sound source position to said sound source.

11) A sound reflecting element for generating a delay deformation corresponding to a relative position between a sound source and sound collecting means, wherein a reflecting surface of said sound reflecting element has an envelope made from a plurality of spheroids that are formed by rotating a plurality of ellipses having the distance between the focal points corresponding to the distance from said sound source to said sound collecting means around an axis connecting said focal points.

12) The sound reflecting element according to claim 11, wherein said plurality of ellipses are generated in relation with the elevation between said sound source and said sound collecting means and flatter as said elevation is greater.

13) The sound reflecting element according to claim 11, wherein said reflecting surface is formed as an enveloping surface of said plurality of spheroids that are generated by rotating a corresponding ellipse around the axis connecting said focal points.

14) A formation method of a sound reflecting element comprising:
generating a delay deformation corresponding to a relative position between a sound source and sound collecting means;
a step of generating a plurality of spheroids by rotating an ellipse having the distance between the focal points corresponding to the distance from said sound source to said sound collecting means around an axis connecting said focal points; and
a step of forming a reflecting surface by generating an enveloping surface of said plurality of spheroids.

15) The formation method of the sound reflecting element according to claim 14, wherein said plurality of ellipses are generated in relation with the elevation between said sound source and said sound collecting means and flatter as said elevation is greater.
